(19) United States
(12) Patent Application Publication
(10) Pub. No.: US 2006/0141097 A1
(43) Pub. Date: Jun. 29, 2006

(54) Symbiotic food products comprising oats and methods for manufacturing the same

(76) Inventor: Mingruo Guo, South Burlington, VT (US)

Correspondence Address: EDWARDS & ANGELL, LLP, P.O. BOX 55874, BOSTON, MA, 02205, US

(21) Appl. No.: 11/111,222

(22) Filed: Apr. 21, 2005

Related U.S. Application Data
(63) Continuation-in-part of application No. PCT/US03/33507, filed on Oct. 22, 2003.
(60) Provisional application No. 60/420,400, filed on Oct. 22, 2002.
(60) Provisional application No. 60/497,278, filed on Aug. 22, 2003.

(51) Int. Cl. A23C 9/12

(52) U.S. Cl. 426/61

(57) ABSTRACT

The invention provides symbiotic beverages, frozen food products based thereon and yogurt-like products. Preferably, the beverage is made by the integration of both probiotic (live microbial food cultures) and prebiotic (non-digestible carbohydrates) supplements that beneficially affect the host by improving the survival and implantation of live microbial dietary supplements in the gastrointestinal tract. Preferably, the beverage is a dairy beverage, a soy-based beverage or a combination thereof, or an oats-based beverage.

### CROSS-REFERENCE TO RELATED APPLICATIONS

This application is a continuation-in-part of PCT application PCT/US03/33507, filed Oct. 22, 2003, which claims priority to U.S. Provisional Application Ser. No. 60/420,400, filed on Oct. 22, 2002, and U.S. Provisional Application Ser. No. 60/497,278 filed Jun. 18, 2003, the entireties of which are incorporated by reference herein.

### FIELD OF THE INVENTION

The invention relates to symbiotic food products, in particular beverages and frozen products based thereon, and yogurt-like products comprising both prebiotic and probiotic components. Preferably, such components are functional in the gastrointestinal tract. Some food products are dairy-based or soy-based beverages or frozen products based on thereon, and yogurt-like products. The invention also provides a symbiotic beverage, frozen product or yogurt comprising oats and a probiotic component, providing an alternative to both dairy and soy products.

### BACKGROUND OF THE INVENTION

Studies have shown that consumers of all ages prefer beverages that are cold, refreshing, satisfying, portable, and healthy. Functional food products are desirable because, in addition to providing adequate nutrition, they beneficially affect one or more target functions in the body. Functional food products have been shown to improve health and wellbeing and/or to reduce the risk of disease (Diplock et al., 1991). Examples of health benefits often addressed by functional foods are: osteoporosis prevention via calcium fortification, prevention of cardiovascular disease, cancer prevention, improved immune responses, and the like.

The term “probiotic” refers a live microbial food supplement, which beneficially affects the host animal by improving its intestinal microbial balance (Fuller, 1992). Lactobacillus acidophilus and Bifidobacterium spp. constitute a major part of the natural microflora of the human intestine (Hammes and Tichaczeek, 1994), and when present in sufficient numbers, create a healthy equilibrium between beneficial and potentially harmful microflora in the gut (Collins and Hardt, 1980). These microorganisms may play a role in inhibiting the growth of pathogenic organisms through production of organic acids and bacteriocins, and by deconjugation of bile salts (Tamura, 1983). The prevalence of these organisms in the intestines may be reduced with age, dietary changes, antibiotic consumption and/or stress, and their absence or low viability may cause varying degrees of digestive problems (Vijayvendra & Gupta, 1992).

The probiotics provided in milk-based products such as yogurt have functional effects on physiology which are ascribed to dairy bacteria present in these products, and the metabolites produced when these bacteria interact with milk medium (Jelen and Lutz, 1998). Since 1908, scientists theorized that fermented milk products provided health benefits (i.e., longer life expectancy). These beneficial effects are usually discussed in relation to three major health claims: namely, improvement of gut health, lowering of blood cholesterol, and improvement of the body's natural defenses, and two most well-documented benefits: improvement of lactose digestion in lactase-deficient individuals, and alleviation of certain types of diarrhea (Lankaputhra and Shah, 1995). For example, some reviews by Mann (2000) report that propiono-acido-bifido (PAB) cultured milk was suitable for feeding both normal and lactose-intolerant infants and children in India, and that a set-type probiotic yogurt using various combinations of starter cultures in which bifidobacteria accounted for 50% of the starter blend was successful in Egypt. Mann also reported that in India, a probiotic yogurt of good nutritional lactose-hydrolyzed condensed whey was produced with a maximum β-galactosidase specific activity.

A “prebiotic” refers to a non-digestible food ingredient that beneficially affects the host by selectively stimulating the growth and/or activity of one or a limited number of bacteria that can improve the host health in the colon. Currently, two soluble but non-digestible dietary ingredients are of great interest in the food industry because of their unique physicochemical and functional properties. Inulin is naturally present in significant quantities in vegetables (e.g., chicory, artichokes, asparagus, salsify, leeks, onions, garlic, even wheat) and is made up of linear chains of fructose molecules connected by β (2-1) linkages with 30-60° of polymerization. Oligofructose is a natural constituent of inulin, except it has 2-7° of polymerization and a slightly higher sweetness index level. Inulin and oligofructose, when ingested, enter the large intestine almost quantitatively and are not hydrolyzed into their monosaccharide moieties in the upper intestinal tract (Orafti, 1999). As a result, they can be recognized as efficient bifidus stimulators or prebiotics in the diet. In addition, oligosaccharides have been recognized for their health benefits in Japan and since the early 1990's many products, especially yogurt drinks, have been developed and are being promoted for their oligosaccharide content.

“Symbiotic” means integrating both probiotics and prebiotics, which in synergy affects the host beneficially by improving the survival and implantation of live microbial dietary supplements in the gastrointestinal tract. Symbiotic products such as yogurts (containing L. reuteri, L. acidophilus, L. casei, Bifidobacteria, and inulin) produced in Switzerland and one of Dutch origin (containing L. acidophilus and raffinose) are now being marketed in Europe (Young, 1997). However, U.S. Pat. No. 6,399,124 reports that bringing the dietary fibers of prebiotics into contact with probiotics such as lactic acid bacteria in a food product has significant disadvantages, including premature destruction of the fibers during the preparation and storage of the product. The patent describes a dessert product which segregates prebiotic and probiotic components.

### SUMMARY OF THE INVENTION

According to the Consumer Beverage Consumption study conducted in late 2000 by Dairy Management Inc.™ (DMI), male and female adults (ages 19-64) and teens (ages 12-18) prefer a cold, refreshing, satisfying, portable, and healthy beverage. The instant invention provides a symbiotic beverage, preferably, an oats-based beverage, that has the nutrition of milk, the health benefits of pre- and probiotics, and in some embodiments, the freshness of carbonation. This invention is designed for consumption by individuals of all ages.

In one aspect, the invention provides a symbiotic product comprising at least one probiotic and at least one prebiotic, and frozen forms thereof. Symbiotic products according to the invention may be in the form of a beverage (a liquid drink, smoothie, or frozen desert such as a popsicle, sundae, smoothie, frusion, and the like). The symbiotic beverage may be a dairy beverage, or a soy-based beverage, or a mixture of the two. In one preferred aspect, a food product, such as a beverage or a frozen food product comprises oats as a prebiotic component and a probiotic component. In one exemplary embodiment, such a food product comprises oats, and may contain skim milk powder, sugar, and whey protein concentrate. In another aspect, an oats-based probiotic beverage according to the invention can be a non-dairy vegetarian product containing no milk, serving as an alternative to both dairy and soy products and providing a vegetarian alternative to dairy-based beverages. Preferably, starch and/or gums are used rather than milk or soy in this embodiment.

In one preferred aspect, a carbonated symbiotic beverage is provided that retains the functionality and survivability of probiotics even after carbonation. More preferably, the characteristics of cultures in the carbonated beverage are beneficially affected by the presence of CO₂. The symbiotic food products according to the invention also are preferably physiochemically and microbiologically stable for up to at least 60 days of refrigerated storage (approximately 4° C.).

In another aspect, the invention provides a symbiotic food product comprising a mixture of probiotic and prebiotic components, wherein the probiotic component comprises at least about 10⁶ Colony Forming Units (CFU)/g of a lactic acid forming microorganism. More preferably, the probiotic component comprises at least about 10⁷ CFU/g of a lactic acid forming microorganism.

In another aspect, the probiotic component comprises a Lactobacillus spp., Bifidobacterium spp., or combination thereof. In a particularly preferred aspect, a combination of five probiotic organisms is included, which are L. acidophilus, L. paracasei subsp. casei and Bifidobacteria, and the required normal yogurt cultures Lactobacillus bulgaricus and Streptococcus thermophilus. For the symbiotic soy beverages, a combination of three cultures (L. acidophilus, L. plantarum (B28) and (B 29)) is used.

In one aspect, for an oats-based beverage, a combination of L. plantarum (B28), L. casei ssp pseudoplantarum (B29) and L. acidophilus is used. In another aspect, the probiotic component of an oats-based beverage comprises bacteria isolated from a Bulgarian cereal-based fermented beverage. Both strains B28 and B29 were isolated from a wheat beverage of Bulgaria, while L. acidophilus was obtained from a commercial source. All strains are viable and show better survivability in the oats beverage.

Another aspect of the invention is an oats-based yogurt-like product. The probiotic component of the yogurt-like product comprises bacteria including Streptococcus thermophilus, L. delbrueckii subsp bulgaricus, L. acidophilus, L. casei, and Bifidobacteria, and may also contain L. plantarum (B29). Some embodiments of the yogurt-like product comprise whey proteins as gelation agents. Advantageously, use of whey proteins in the place of gelling agents such as gums provides additional beneficial functional components.

In a further aspect, the prebiotic component comprises inulin or an oligofructose. Preferably, the prebiotic component comprises 2-60° of polymerization and is about 1-3% by weight of the product. Also preferably, the probiotic component provided in the product inhibits the growth of one or more pathogenic micro-organisms in the gastrointestinal tract.

In one aspect, as described above, the symbiotic food product is in the form of a beverage. Preferably, the beverage is a carbonated beverage comprising 0.5-2.0 volumes of CO₂. In another aspect, the symbiotic food product is in a frozen form (e.g., such as in the form of a popsicle).

The invention also provides a method of manufacturing a symbiotic food product comprising a mixture of prebiotic and probiotic components wherein the method comprises: combining prebiotic and probiotic components in a food product to form an inoculated mixture; fermenting the inoculated mixture until a pH of about 4.5 is achieved; and agitating the mixture to produce a beverage or, optionally, freezing the mixture to form a frozen food product such as a popsicle. In one aspect, where a beverage is being produced, the method comprises an additional step of introducing CO₂ into the beverage and sealing the CO₂-containing beverage within a container. Preferably, 0.5-2.0 volumes of CO₂ are introduced into the beverage.

In still another aspect, the invention provides a method for producing an oats-based beverage comprising probiotics and oats. A mix of oats, skim milk powder or other stabilizers, a sweetener such as sugar and/or other flavorings, whey protein concentrate, soy protein products and a probiotic component is fermented until one or more of: a good viscosity (e.g., 400-4000 mPas), a satisfactory pH (e.g., from about 2.5-4.5, preferably, from about 2.99 to about 4.02) and a good titratable acidity (TA) is obtained (e.g., from about 0.05-0.50, preferably from about 0.10-0.17). In a preferred aspect, the fermentation proceeds until a viscosity of about 400-450 mPas, a pH from about 2.5-4.5, and a TA of from about 0.10-0.20 is obtained. The oats-based beverage can comprise additional components such as protein, fat, vitamins, etc. Preferably, about 1%-10% oats, and more preferably from about 2%-5% oats are used as a prebiotic component.

In another aspect, the invention provides a method for identifying one or more strains of lactic acid-producing bacteria for use in generating a symbiotic food product. The method comprises introducing one or more strains of such bacteria into a food product, such as a dairy or soy-based beverage, or a non-dairy based beverage comprising prebiotic components (such as oats), as described above, and selecting for bacteria with good survival rates (e.g., ≧10⁶ CFU/ml).

In still a further aspect, the beverage is also carbonated and bacteria are identified which are able to grow in the presence of 0.5-2.0 volumes of CO₂ in the presence of prebiotic components as described above. Preferably, the bacteria also have antimicrobial effects, such as the ability to inhibit the growth of pathogenic bacteria that may grow in the gastrointestinal tract.

The invention also provides starter cultures of bacteria identified by the method.

### BRIEF DESCRIPTION OF THE DRAWINGS

The objects and features of the invention can be better understood with reference to the following detailed description and accompanying drawings.

FIG. 1 is a schematic diagram which illustrates manufacturing technology which can be used to prepare symbiotic food products according to the invention.

FIG. 2 shows the effect of fermentation time on the viscosity of an oats-based beverage according to one aspect of the invention.

FIG. 3 shows the effect of fermentation on the pH of an oats-based beverage according to one aspect of the invention.

FIG. 4 shows the effect of fermentation on the titratable acidity of an oats-based beverage according to one aspect of the invention.

### DETAILED DESCRIPTION

The present invention relates to a symbiotic food product which comprises probiotic and prebiotic components. Preferably, the prebiotic component comprises oats. More particularly, the invention relates to a liquid, semi-liquid, or frozen food product which comprises these components. In one preferred aspect, the invention provides a carbonated symbiotic beverage with both probiotic and prebiotic components which remain functional upon ingestion. The invention also provides methods for manufacturing such products.

### Probiotic Components of Symbiotic Food Products

As previously discussed, the most important characteristic of probiotic bacteria is a positive effect on human health. However, the functionality of these bacteria in the intestine and survival in dairy or soy-based products are also essential to the invention. “Functionality” can be measured in terms of: growth; lactase activity; antibiotic resistance; bile salt hydrolase activity; ability to grow on prebiotics; bile and acid resistance; antimicrobial inhibition; hydrogen peroxide production; and survival in a food product such as fluid milk and yogurt, or a soy-based product, or an oats-based product as described further below. Taxonomy and strain relatedness may play a role in both functionality and survival. Basic methodology for producing probiotic food products and probiotic cultures, and alleged health benefits to humans or animals is vast and readily available (IDF, 1996; Gorbach, 1997; Hughes & Hoover, 1991; Gilliland, 1979; Reddy, et al., 1983; Surono & Hosono, 1996).

One food of choice to implement probiotic cultures is yogurt, which has a relatively low pH (˜4.5). Different species and even strains of probiotic cultures (e.g., Lactobacillus spp, Bifidobacterium spp., etc.) have been known to vary widely in their ability to grow and survive in such acidic environments. Lactobacillus spp. have an advantage of being well suited for adapting to growth in the large intestine. Further, Lactobacillus spp. have a number of health enhancing properties. For example, when cultured in milk or soy milk, Lactobacillus acidophilus increases the concentrations of vitamins in milk. Lactobacillus acidophilus can produce a significant amount of an antibiotic activity, while being harmless to both children and adults. Co-culturing it with Streptococcus in milk can boost the antibiotic properties of Lactobacillus acidophilus. This appears to stimulate growth on the part of both species. Thus, in co-culture, the acid-forming properties of each strain are enhanced. See, e.g., U.S. Pat. No. 6,368,641.

Other suitable probiotic components include, but are not limited to, Lactobacillus bulgaricus and Streptococcus thermophilus supplemented with Lactobacillus acidophilus, Bifidobacterium bifidum, Bifidobacterium infantis, Bifidobacterium longum, and other combinations thereof. Particularly preferred components or combinations of components comprise Lactobacillus spp. and Bifidobacterium spp., both of which have been demonstrated to produce enhanced mucosal and systemic IgA responses to toxins (see, e.g., Tejada-Simon, J. Dairy Sci. 82(4): 649-60, 1999). Preferred Bifidobacterium spp. include strains which survive at low pH, i.e., in the pH range typically found in the stomach, e.g., strains such as Bifidobacterium longum.

Additional preferred strains are those that are capable of adhering to human intestinal cells and of excluding pathogenic bacteria from human intestinal cells. Among the lactic acid bacteria recognized with these properties are: Lactobacillus plantarum 299, Lactobacillus rhamnosus ATCC53103, Lactobacillus acidophilus CNCM I-1225, Bifidobacterium breve CNCM I-1226, Bifidobacterium infantis CNCM I-1227 and Bifidobacterium longum CNCM I-1228. See, e.g., EP 577904; EP 577903; EP 199535; U.S. Pat. No. 5,591,428, Gut, 35: 483-489, 1994; J. of Dairy Science, 78, 491-497, 1995; Applied Env. Microb., 59, 4121-4128, 1993.

Additional strains which can provide suitable probiotic components include, but are not limited to: Lactococcus lactis, in particular L. lactis subsp. cremoris and L. lactis subsp. lactis biovar diacetylactis; Streptococcus thermophilus; the groups of acidophilic bacteria consisting of Lactobacillus crispatus, Lactobacillus amylovorous, Lactobacillus gallinarum, Lactobacillus gasseri and Lactobacillus johnsonii; Lactobacillus rhamnosus, Lactobacillus brevis; Lactobacillus fermentum; Lactobacillus plantarum; Lactobacillus helveticus; Lactobacillus casei (in particular, L. casei subsp. casei and L. casei subsp. Rhamnosus); Lactobacillus delbruckii (in particular L. delbruckii sbp. lactis and L. delbruckii sbp. Bulgaricus); bifidobacteria such as Bifidobacterium infantis, Bifidobacterium breve, and Leuconostoc mesenteroides (in particular, L. mesenteroides subsp. cremoris), and combinations thereof, for example (see, e.g., Bergey's Manual of Systematic Bacteriology, vol. 2, 1986; Fujisawa et al., Int. Syst. Bact, 42, 487-491, 1992).

Preferably, a symbiotic food product according to the invention comprises greater than about 10⁶ CFU/g, greater than about 10⁷ CFU/g, or greater than about 10⁸ CFU/g of lactic acid forming bacteria. Preferably, cultures used in the instant invention have growth rates of about 10⁸-10⁻¹⁰ CFU/g, and survival rates of at least about 10⁶ CFU/g in an acidic environment (pH≦5).

More preferably, the bacteria have one or more of the following properties: bile salt hydrolase activity, hydrogen peroxide production, ability to grow on prebiotics (less than about 50% inhibition of growth on prebiotics, and preferably less than about 80%, or about 0% inhibition) and bile acid resistance (less than 50% cell death in the presence of bile acids in amounts typically found in the gastrointestinal (GI) tract). Cultures also, preferably, demonstrate resistance to antibiotics (e.g., greater than 50% inhibition of cell killing or less than 50% inhibition of cell division in the presence of an antibiotic), and more preferably, have antimicrobial activity, i.e., inhibiting the growth of pathogenic bacteria in the GI tract.

In one preferred aspect, in which the prebiotic component of the food product is oats, the probiotic comprises one, two, or all three of L. plantarum (B28), L. casei ssp. pseudoplantarum (B29) and L. acidophilus. In another aspect, the probiotic component comprises one or more strains of bacteria isolated from a fermented cereal such as Bulgarian cereal. Such bacteria include, but are not limited to: L. bulgaricus and Streptococcus thermophilus.

### Prebiotic Components of Symbiotic Food Products

The beneficial effects of the presence of probiotics in the gastrointestinal tract are dependent on their viability and metabolic activity, aided by the presence of complex carbohydrates and other factors. Prebiotic dietary fibers are generally polysaccharides and behave like growth factors for certain lactic acid bacteria. Prebiotic components, also described as bifidogenic factors, are described in EP 726272, U.S. Pat. No. 4,435,389, and Nakakuti, J. of Japan, 167: 116-121, 1996, for example.

To maximize the effectiveness of the bifidus-containing products, the bifidogenic factors are often included in the product itself. In general, bifidogenic factors are mostly short-chain oligosaccharides (3-10 monosaccharide units) with unique functional properties, as they are not well digested by stomach acids and appear to stimulate the growth of bifidobacteria and lactobacillus, increase bioavailability of calcium and magnesium, and prevent some stages in carcinogenesis (Roberfroid, 1997; Oku, 1994).

In recent years, derivatives of lactose have been one of the substrates used for production of bifidogenic factors such as lactulose, lactitol, or lactosucrose. As mentioned above, bifidogenic factors are also found in many natural sources including chicory, Jerusalem artichokes, onion, leek, soybean, and other plants. Factors such as inulin and oligofructose also are preferred bifidogenic factors.

In one aspect, the invention provides a symbiotic food product, preferably in the form of a beverage or dessert comprising probiotic and prebiotic components, wherein the prebiotic component is a prebiotic such as inulin or oligofructose. Preferably, the prebiotic component is selectively fermented in the presence of the probiotic component, increasing the presence of the probiotic component and the production of fermentation end products. More preferably, the production of these end products results in a lower pH in the digestive tract which has an antimicrobial effect on harmful bacteria such as Escherichia coli, Clostridium perfringens, and Clostridium difficile. In one aspect, fermentation of the prebiotics also increases the presence of short chain fatty acids in the GI and inhibits the growth of pathogenic bacteria.

In one aspect, the prebiotic is a fructooligosaccharide. As discussed above, prebiotics can be extracted from natural substances such as plants. However, fructooligosaccharides also can be synthesized from sucrose through the use of tranfructosylating enzymes. Treatment of sucrose with the transfructosylating enzyme from Aspergillus niger results in fructooligosaccharides containing 2-4 fructose residues. Enzymatic methods of producing prebiotics are described in U.S. Pat. No. 4,681,771, U.S. Pat. No. 5,318,794, U.S. Pat. No. 5,206,355, and WO 94/27618. Methods for isolating inulin are described in U.S. Pat. No. 6,303,778, for example. Preferably, prebiotics according the invention have a degree of polymerization ranging from about 2° to about 60° and are resistant to digestion in the human upper GI. More preferably, prebiotics are present in symbiotic dairy products according to the invention at levels from about 2.0-5.0 grams, or about 1-3% of the weight of the product.

In another preferred aspect, the prebiotic component is oats and is present in about 1-7% of the weight of the product, and preferably about 2-5% of the weight of the product.

### Dairy Products

Probiotic bacteria are suitable for supplementing a variety of dairy products, including fluid and fermented milk and yogurt products. Low-fat, non-fat, and soy milk can be used. The symbiotic food products according to the invention may be provided in a number of edible forms such as beverages and frozen dessert products. Beverages include fluid drinks and drinks with thicker consistencies, e.g., such as smoothies. Frozen desserts encompassed within the scope of the invention include, but are not limited to, popsicles, ice cream-like desserts, and the like.

A key to successful long-term marketing of any probiotic is the organism's ability to survive until the time of consumption at levels that ensure viable organisms in the intestinal tract, which are at least 10⁶ to 10⁸ and preferably 10⁷ viable cells per milliliter or gram of product. In addition to their health benefits, probiotic species selection for use in dairy foods is based on their ability to survive manufacturing conditions, as well as storage and distribution times and temperatures. Some of the technological concerns are the low oxygen tension requirement of the probiotic cultures, and the prevention of over-agitation of the product to produce excess oxygen that can destroy the cultures. Since carbon dioxide (CO₂) is more soluble in water than oxygen, it displaces oxygen and may minimize degradation reactions such as oxidative rancidity. Therefore, in one particularly preferred aspect, the invention provides a symbiotic carbonated dairy beverage, preferably a yogurt beverage, comprising both probiotic and prebiotic components.

### Soy-Based Beverages

In one aspect, the invention provides a symbiotic beverage that comprises soy protein. Soy protein concentrates and soy protein isolates are important derivatives of soybeans which are used primarily as food and feed ingredients. Conditions typically used to prepare soy protein isolates have been described in U.S. Pat. No. 4,278,597 and U.S. Pat. No. 4,072,670. Soy protein concentrates are produced by three basic processes: acid leaching (at about pH 4.5), extraction with alcohol (about 55-80%), and denaturing the protein with moist heat prior to extraction with water. Conditions used to prepare soy protein concentrates have been described in U.S. Pat. No. 3,897,574, for example.

In one aspect, a symbiotic beverage is prepared by preparing soy flour or flakes from soybeans; contacting the material with a solvent to remove at least some of the dietary fiber; collecting the soluble material obtained by centrifugation or other equivalent physical means; and adding the material to water or to milk to form a soy beverage. Prebiotic components are added as described above. Additional flavorings and stabilizers also may be added.

Preferably, the soy beverage is then inoculated with about 0.5-1.0 g/l of a probiotic culture. The inoculated beverage is incubated for a suitable period of time until a desired thickness is achieved (e.g., at 45° C. for 7-8 hours). Although lactic organisms will grow in a soy base, a combination of soy and milk protein bases yields a product that is more typical of yogurt. In one aspect, a dispersion comprising a 0.5:1; 1:1; or 1.5:1 ratio of dried soy protein to milk solids (preferably, non-fat milk solids) is prepared. The dispersion is heated (e.g., to 80° C. to 90° C. for about 30 minutes and then cooled to 45° C.). The dispersion is then inoculated with 0.5 to 1.0 g/l of probiotic culture and incubated as described above. Prebiotic components can be added before or after incubation. Various flavorings such as sugar, corn syrup, fruit juices, pureed fruits, and the like can be added, to make the product more palatable. Additionally, the product can be frozen to make popsicles, smoothies, and the like.

### Symbiotic Products With Oat-Based Prebiotic Components

In one preferred embodiment, a non-dairy vegetarian product comprising oats as a prebiotic component, and a probiotic component is provided. An exemplary beverage of this type is formulated by mixing a prebiotic component comprising 3-10%, and preferably 5%, oats, with flavoring ingredients and nutritional supplements (e.g., such as sugar, whey protein concentrate, fruit juices and other flavorings) and fermenting the formulated mix using one or more probiotic components. In one preferred aspect, the mix is fermented using a combination of L. plantarum (B28), L. casei ssp. pseudoplantarum (B29) and L. acidophilus at concentrations greater than from 10⁶ CFU/g to about 10⁸ CFU/g until a desired pH, titratable acidity and viscosity is achieved, e.g., 24-72 hours, preferably about 48 hours. Bacteria isolated from Bulgarian cereal-based fermented beverage also have probiotic properties and are able to ferment oats.

Another preferred oat-based product is in the form of a yogurt-like fermented oat product. An exemplary product of this type is formulated by mixing oats ingredients comprising 3-10%, and preferably about 5%, oats, with flavoring ingredients and nutritional supplements as described above for an oat-based beverage, and a gelation agent comprising whey protein products (WPC/WPI). Additional prebiotic components such as inulin may be added in some embodiments. An oat slurry (e.g., about 5% oat flour, 7% sugars) comprising the above components is sterilized, for example at 120° C. for 15 minutes.

The sterilized oat slurry containing polymerized whey proteins is mixed with at least one, and preferably a mixture of, probiotic organisms selected from Streptococcus thermophilus, L. delbrueckii subsp bulgaricus, L. acidophilus, L. casei, and Bifidobacteria. The mixture containing prebiotic and probiotic components is fermented (e.g., at about 43° C. for about 4 h) to produce a yogurt-like product having the desired pH, titratable acidity and viscosity.

### Carbonated Beverages

CO₂ is a colorless, odorless, noncombustible gas, liquefiable to a heavy, volatile, colorless liquid (Ringo, 1999). The function of CO₂ in beverages is to provide freshness, effervescence, some acidity, and some protection against microbiological growth without contributing any off-appearances, off-odor, off-taste, or undesirable levels of trace impurities. In addition, CO₂ is a naturally occurring ingredient in raw milk and is generally regarded as safe (GRAS), which allows for an “all-natural” claim. The cost of adding CO₂ to dairy foods is surprisingly small, and modifying the usual production process is fairly simple. The only changes are adding a CO₂ supply with a sanitary, in-line sparging device to an existing line and including a flow meter for measuring the gas (Hotchkiss and Chen, 1996).

Therefore, the invention provides the addition of CO₂ in sufficient amount during production to help ensure proper inoculum levels (10⁶-10⁸ CFU/g) in the final culture counts in consumer products. Techniques of introducing CO₂ during the manufacturing process to produce a carbonated beverage are described further in an Example below.

### Supplemental Ingredients

Symbiotic dairy products according to the invention also can be supplemented by a variety of other ingredients to increase the functionality of the product and/or to increase the product's appeal. For example, products may be supplemented by vitamins, iron, calcium, proteins, potassium, phosphorus, folate, magnesium, lactoferrin (e.g., iron-saturated or iron-free lactoferrin), and the like.

Stabilizers such as pectin, locust bean gum, xantham gum, guar gum, and the like, are used in amounts necessary to achieve a desired level of viscosity and emulsion stability of the product (e.g., a beverage). Additional ingredients may be provided to increase nutritional value and/or taste appeal of the product. For example, fruits (pieces, purees, juices) may be provided. Non-milk fat sources may also be provided, such as coconut oil. Other ingredients may be provided to increase the attractiveness of the product, such as colorings. FDA-approved natural colorings include, but are not limited to: beet extract, carmine, annatto, and turmeric.

### Manufacture Of Symbiotic Food Products

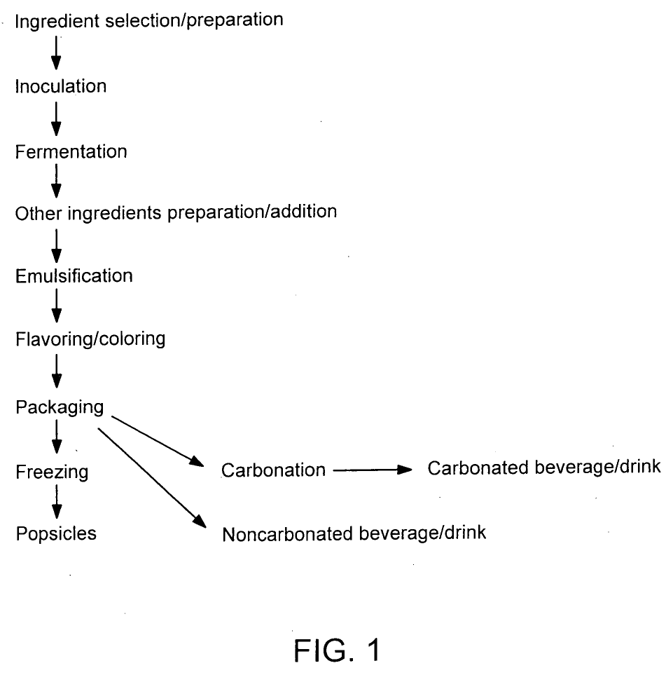

FIG. 1 provides a schematic diagram illustrating basic steps in manufacturing symbiotic food products according to the invention. As can be seen from the figure, after selecting appropriate ingredients (e.g., suitable probiotic cultures, prebiotic components, supplemental ingredients and dairy or soy-based products), these are mixed together and the mixture is incubated under suitable conditions to allow fermentation to occur (e.g., allowing production of lactic acid by the probiotic components of the culture and expansion of the starting culture).

Yogurt is generally manufactured in accordance with the following procedure: the milk or soy-based product to be used is pasteurized and cooled from the pasteurization temperature to an incubation temperature of from 110°-120° F. A culture of appropriate probiotic organism(s) is added to the milk. Suitable yogurt cultures are usually obtained as a lyophilized powder or frozen liquid and are pre-activated prior to adding the yogurt cultures to the base mix. Pre-activation is performed by adding the lyophilized powder or frozen liquid to a suitable growth medium such as whole milk, skim milk, non-fat milk, a soy-based beverage (with or without milk), or an oats-based beverage or mix, and permitting the yogurt culture to attain a viable, rapidly growing condition. The inoculated mix is fermented until the desired acidity is attained, which usually occurs in three to five hours. Exemplary conditions for inoculation and fermentation are described further in an Example below.

The mixture is then stabilized and suitable flavorings and colorings may be added before or after emulsification. The mixture is then processed depending on the final form desired. For example, if incubation is permitted to take place without agitation, a gel-like body is obtained. If agitated, the product can be liquidified to generate a suitable beverage. The beverage may be carbonated to produce a carbonated beverage, or packaged as a non-carbonated beverage. The mixture also can be frozen, to create a dessert product such as a popsicle. As can be seen from FIG. 1, the manufacturing process can be adapted to provide for all three outcomes, allowing a carbonated beverage, non-carbonated beverage, and frozen desert to be manufactured all from the same production run.

Batches of product are assayed for functionality such as growth, lactase activity, antibiotic resistance, bile salt hydrolase activity, bile and acid resistance, antimicrobial effect, hydrogen peroxide production, and survival. Analyses of physiochemical properties including the contents of protein, fat, total solids, lactose and minerals, titratable acidity and pH values, and microbiological properties (i.e., SPC, mold and yeast) of the product also may be performed.

Shelf-life stability of the product is determined by changes in the estimation of SPC, mold and yeast, and survivability of the probiotics during refrigerated storage. Preferably, products according to the invention are functional in the gastrointestinal tract after up to at least 60 days of refrigerated storage.

### EXAMPLES

The invention will now be further illustrated with reference to the following Examples. It will be appreciated that what follows is by way of example only and that modifications to detail may be made while still falling within the scope of the invention.

### Example 1

### Manufacturing Scheme for Symbiotic Dairy Products

The following describes an exemplary manufacturing scheme for preparing a symbiotic dairy product according to one aspect of the invention.

### Ingredient Preparation

The following ingredients are selected for a symbiotic yogurt beverage: 2% fat pasteurized milk; Grade A nonfat dry milk; natural pectin or locust bean gum; inulin or oligofructose; a L. acidophilus starter culture; commercial Bifidobacterium spp. Other minor ingredients may also be provided.

Fermentation:

Pasteurized milk or reconstituted nonfat dry milk (10%, w/v) is fortified with inulin or oligofructose at 0% or 3%. The mix is heated to 75° C. for 5 minutes and cooled to 43° C. before inoculating the probiotic cultures. The mix is incubated at 43° C. for 4-6 hours or until pH of about 4.5 is achieved.

Formulation and Homogenization:

The symbiotic yogurt is formulated by using 40% of the yogurt base described above, 0.2% stabilizer (e.g., pectin), 6-8% sugar (optional), and 60% filtered and sterilized water. The mix is homogenized at 2,500 psi at 40° C.

Carbonation and Packaging:

Carbonation and packaging of the products is performed using a Zahm™ pilot scale stainless steel carbonator (9000-R) and a filler (15 gallon capacity, Zahm and Nagel Co. Inc., Holland, N.Y.). High-density polyethylene terephthalate (HDPET) screw-capped plastic bottles (8 or 12 oz) are used for the containers of the beverage. Carbonation levels are arranged from 0 to 1.5 volumes (0-3000 ppm), or even higher (2 volumes).

Laboratory-scale batches of symbiotic yogurt beverage containing Lactobacillus acidophilus NCFM or Bifidobacterium bifidus Bb-11 are formulated with 0 (control), 0.5, 1.0, or 1.5 volumes of CO₂, and the same concentration (3%) of inulin or oligofructose on the same day. The differences in CO₂ concentration levels among the two symbiotic yogurt beverages with different probiotic content are evaluated statistically according to a complete randomized block 2×2×4 analysis of variance using the SAS Software Rel 6.12 TS045 program for Windows. Significance of differences is defined at P≦0.05.

### Evaluation Of Functional Properties:

Viscosity:

Product samples are measured in triplicate using a Brookfield Synchro-Electric Viscometer (Model LVT, Spindle No. 18, Brookfield Engineering Laboratories, Staughton, Mass., USA), equipped with a small sample adaptor and temperature-controlled chamber.

Emulsion Stability:

Product samples are measured in triplicate according to a phase separation technique adapted from Tomberg (1978) in which the stability rating (SR) is based on percentage change in fat in the lower aqueous phase after separation. The emulsion samples (16.5 g) are transferred to tubes 21 mm in diameter and with tapered, stoppered ends, and held for 24 hours at room temperature. A sample (5 g) is then removed from the lower phase of the emulsion and analyzed for fat by the Gerber method, as used for cream:

$$The SR ( \% ) = \frac{fat in lower phase , \%}{fat in original emulsion , \%} \times 100$$

Chemical Analysis:

All chemical analyses are conducted in triplicate. Crude protein contents are determined by the Kjeldahl semi-micro block digestion method (IDF, 1993). Fat contents are determined by the Babcock method (Marshall, 1992). Total solids are measured by drying in a forced-draft oven at 100° C. for 12 hours. The pH value and titratable acidity of the products are measured according to standard methods (Bradley et al., 1992). Mineral contents are measured using Inductively Coupled Plasma Atomic Emission Spectroscopy (ICPAES, Leeman Labs Plasma Spec Z.5, Lowel, Mass.) after the samples have been digested in a mixture of HNO₃ and HClO₄ (1:5) on a hot plate until clear, as described by Guo and Kindstedt (1995). Contents of lactose are analyzed by the enzymatic method (AOAC, 1984).

### Evaluation of Product Stability

Standard Plate Count (Class O):

An estimation of bacterial populations in the product samples is performed according to microbiological count methods by Houghtby et al. (1992).

Mold and Yeast (Class A2):

Estimation of mold and yeast in the product samples is performed according to methods by Frank et al. (1992).

### Survivability of Probiotic Cultures

Evaluation of Probiotic Characteristics of the Cultures in the Prototype:

1. Enumeration of L. acidophilus

To maintain L. acidophilus strains, MRS medium (broth, agar slopes) is used (Nighswonger, 1996). The strains are transferred in fresh medium every 20-30 days and incubated under anaerobic conditions at 37° C. for 24-48 h.

MRS broth preparation is as follows: 55 g/l dehydrated Lactobacilli MRS broth (Difco, Becton Dickinson and Co., USA) and distilled water are mixed and sterilized at 121-124° C. for 15 minutes. The final pH is 6.5±0.2. For MRS agar, 2% agar is added before autoclaving.

For selective enumeration of L. acidophilus (Sanders et. al., 1996; Vinderola & Reinheimer, 2000) when applied within a mixed starter together with L. bulgaricus and Streptococcus thermophilus, B-MRS (Bile-MRS) medium is used.

B-MRS preparation comprises mixing 55 g/l dehydrated Lactobacilli MRS broth, 0.15% w/v Oxgall (dehydrated fresh bile, Difco), 2% agar, and distilled water.

For obtaining total CFU counts of lactic acid bacteria, MRS agar is suitable. To obtain CFU counts, appropriate dilutions of the samples in sterile peptone water are prepared and 0.1 ml of the dilutions are plated on the media. Peptone water may be prepared by mixing 0.1% (w/v) Peptone, with distilled water, and autoclaving the mixture at 121° C. for 15 minutes. CFU counts are performed by incubating plates of MRS agar anaerobically at 37° C. for 48 hours. To maintain anaerobic conditions, Anaerogen kits (Oxoid) can be used. Plates of B-MRS agar are incubated aerobically at 37° C. for 48 hours and the numbers of CFU are counted.

2. Enumeration Of Commercial Bifidobacteria

Components for the preparation of LP-MRS (lithium chloride-sodium propionate agar) is as follows: 55 g/l dehydrated Lactobacilli MRS broth, 0.2% w/v LiCl (Fisher Scientific), 0.3% w/v Na-propionate (Acros Organics, USA), 2.0% agar, and distilled water. Media is autoclaved at 121° C. for 15 min (Shah et. al., 1995).

CFU counts are performed by incubating plates of MRS agar anaerobically, and the numbers of CFUs are counted.

3. Bile Injury

The strain biomass is transferred into fresh MRS broth and incubated overnight at 37° C., and then inoculated at 1.0% into prepared MRS broth containing bile salt at concentrations 0, 0.25, 0.5, 1.0, 2.0, and 3.0% of oxgall with, or without, carbonation (1.5 volumes). Samples are taken every 30 min for optical density measurement at wavelength 560 nm as a growth index of the cultures. The corresponding non-inoculated broth is used as a blank (Marteau et. al., 1997).

Survival and growth of the strain(s) indicates resistance to the tested bile salt concentration. If growth is not clearly indicated, plate counts from the initial and the final suspensions are made to assess strain survivability under the condition tested.

4. Acid Resistance/Tolerance

The strain biomass is transferred into fresh MRS broth and incubated overnight at 37° C. MRS broth with a different pH (2.0, 2.5, 3.0, adjusted with 2 M HCl), and with or without carbonation (1.5 volumes), is inoculated with the biomass suspension at 1.0% and incubated at 37° C. Samples are taken every 30 minutes and the optical density is measured at 560 nm to obtain an estimate of growth. Non-acidified MRS broth is inoculated as a control. Corresponding non-inoculated broth is used as a blank (Charteris et al., 1998).

Survival and growth of the strain indicates its resistance to a certain acidity. If growth is not clearly indicated, plate counts from the initial and the final suspensions should be made to assess strain survivability under the condition tested.

### Example 2

### Oat-Based Symbiotic Beverage

The objectives of this study were to optimize the fermentation conditions to develop a beverage using probiotics and oats with acceptable sensory and nutritional qualities.

Oats, skim milk powder (SMP), sugar, whey protein concentrate (WPC) were used for the formulation. The formulated mix was fermented using L. plantarum (B28), L. casei ssp pseudoplantarum (B29) and L. acidophilus.

Changes in pH, titratable acidity (TA), viscosity and growth of cultures were determined for three prototypes: a) 5% oats; b) 5% oats+0.5% WPC; and c) 5% oats+8% sugar; samples were taken every 12 h up to 72 h of fermentation at 37° C.

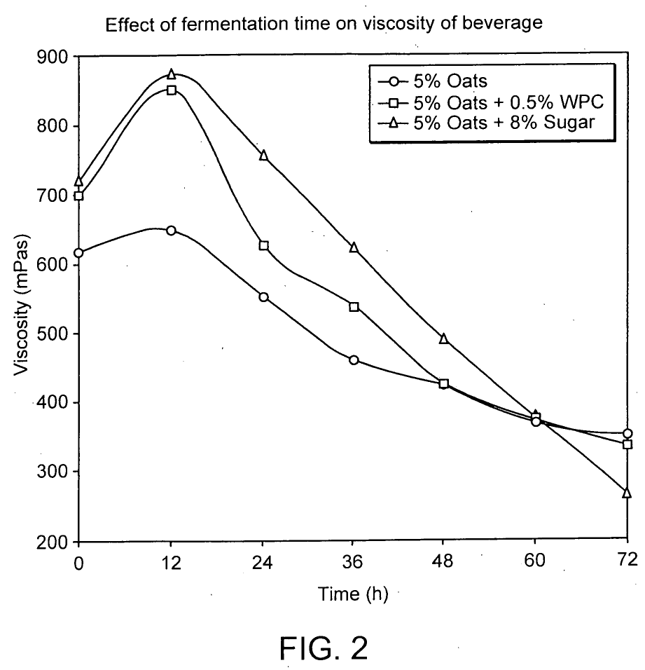

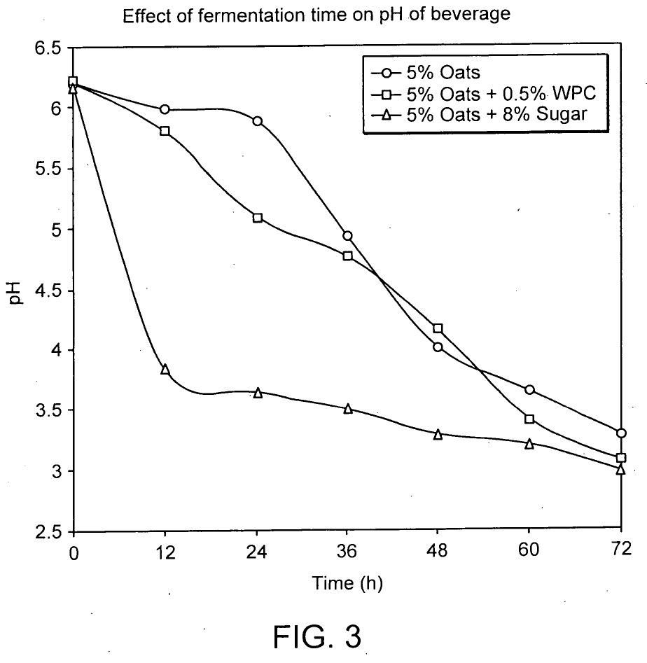

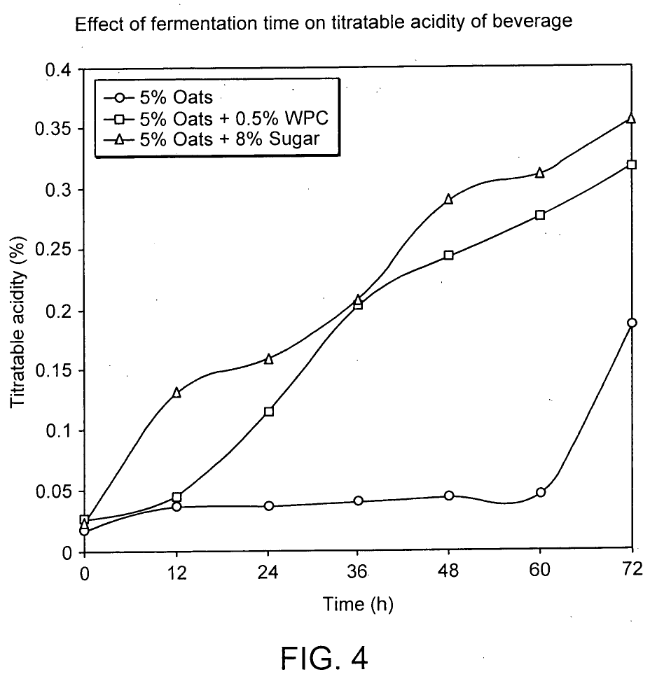

The results are presented in FIGS. 2, 3, and 4. The probiotic count (10⁸) was maintained throughout the fermentation time. The results indicated that fermenting for 48 h gives an acceptable product with acceptable probiotic count. Prototypes a), b) and c) had viscosity 411, 420 & 407 mPas; pH 4.02, 3.95 and 2.99; TA 0.10, 0.17 and 0.39%; 0.6, 1.0, 0.6% protein, and 0.25, 0.29, 0.24% fat, respectively.

In conclusion, oats can be used as a base for developing a probiotic non-dairy beverage.

From preliminary studies, bacteria isolated from Bulgarian cereal-based fermented beverage were found to have probiotic properties able to ferment oats. In this product, two beneficial components, i.e., soluble fiber of oats and probiotics, are combined to have the benefit of the synergistic effects.

Oats-based probiotic beverages may be provided as non-dairy vegetarian product containing no milk. This may serve as an alternative to both dairy and soy products.

### Example 3

### Yogurt-Like Oat-Based Symbiotic Product

This Example describes the production of a yogurt-like fermented oat product.

Formulation and Production Methods:

The fermented oat product was formulated using oat flour, sugar, and pre-polymerized whey protein isolate (WPI) as the gelation agent. An oat slurry (5% oat flour, 7% sugars) was sterilized at 120° C. for 15 min. The sterilized oat slurry and polymerized whey proteins were fermented at 43° C. for about 4 h using YoFast 10 commercial starter culture and probiotic mix (Chr. Hansen), which contains Streptococcus thermophilus, L. delbrueckii subsp bulgaricus, L. acidophilus, L. casei, and Bifidobacteria.

Product Analysis:

Chemical composition of the prototype product was analyzed for total solids, fat, soluble fiber, insoluble fiber, and ash. Results of this analysis are shown below:

| | |
|---|---|
| Total solid content | 10.8% ± 0.1 |
| Fat content | 1.34% ± 0.2 |
| Soluble fiber content | 0.22% ± 0.1 |
| Insoluble fiber content | 0.83% ± 0.3 |
| Ash content | 0.1% ± 0.0. |

The product had the following functional properties:

| | |
|---|---|
| pH | 4.3 ± 0.0 |
| Viscosity | 940 ± 36.1 mPas |
| Titratable acidity | 0.14% ± 0.01. |

The concentrations of other analytes were as follows:

| | |
|---|---|
| Calcium | 7.5 ± 0.2 |
| Magnesium | 7.2 ± 0.6 |
| Potassium | 18.3 ± .8 |
| Sodium | 7.8 ± 0.3 |
| Iron | 0.3 ± 0.0 |

One preferred formulation according to the invention comprised ingredients and percentages as shown:

| | |
|---|---|
| Oats | 5.28% |
| Lactase | 1.05% |
| Sugar | 6.41% |
| Inulin | 0.6% |
| YoFast-10 | 0.06% |
| ABC-1 | 0.5% |
| WPI | 0.6% |

Analysis of the exemplary formulation indicated that an oat-based yogurt-like product containing probiotics can be formulated and manufactured.

Variations, modifications, and other implementations of what is described herein will occur to those of ordinary skill in the art without departing from the spirit and scope of the invention as described and claimed herein. Such variations, modifications, and implementations are encompassed within the scope of the invention.

All of the references identified herein and below are hereby expressly incorporated herein entirely by reference.

### REFERENCES

Collins, E. B. and Hardt, P. 1980. Inhibition of Candida albicans by Lactobacillus acidophilus. J. Dairy Sci. 5:830-832.
Diplock, A. T., Aggett, P. J., Ashwell, M., Bomet, F., Fern, F. B., and Roberfroid, M. B. 1991. Scientific concepts of functional foods in Europe: consensus document. Br. J. Nutr, 81 supp. 1 S1-S28.
Fuller, R. 1992. Ch. 1: History and development of probiotics. In Probiotics, the Scientific Basis. Chapman & Hall, Van Nostrand Reinhold Inc., New York. Pp. 1-8.
Gibson, G. R. and Williams, C. M. 2000. Functional foods: concept to product. Woodhead Publishing Limited, Cambridge, England and CRC Press LLC, Boca Raton, Fla. 1-5.
Gilliland, S. E. 1979. Beneficial interrelationships between certain microorganisms and humans: candidate microorganisms for use as dietary adjuncts. J. Food Protection 42:164-167.
Gorbach, S. L. 1997. Health Benefits of Probiotics, IFT Annual Meeting, Orlando, Fla., Abstract 73-1.
Griffin, M. 1997. Exceptional growth in probiotic products. Dairy Outlook 2: No 4. Rome, FAO.
Hammes, W. P. and Tichaczeek, P. S. 1994. The potential of lactic acid bacteria for the production of safe and wholesome food. Z-Lebensm-Uters-Forsch. 198(3): 193-201.
Hilliam, M. 1996. Functional foods: the western consumer viewpoint. Nutrition Reviews 54(11): S189-194.
Hotchkiss, J. H. and Chen, J. H. 1996. Microbiological effects of the direct addition of CO₂ to pasteurized milk. J. Dairy Sci. 79 (Supplement 1):87.
Hughes, D. B. and Hoover, D. G. 1991. Bifidobacteria: their potential use in American dairy products. Food Technology 45(4):74-83.
IDF. 1996. Oligosaccharides and Probiotic Bacteria. Bulletin 313, Brussels, Belgium: International Dairy Federation. pp. 9-64.
Jelen, P. and Lutz, S. 1998. Functional milk and dairy products. Functional Foods: Biochemical and Processing Aspects, Mazza, G., Lancaster, Pa.: Technomic Publishing Company, Inc. pp. 357-380.
Lankaputhra, W. E. V. and Shah, N. P. 1995. Survival of Lactobacillus acidophilus and Bifidobacterium spp in the presence of acid and bile salts. Cultured Dairy Products J. Vol. 30, No. 3, p. 2-7.
Mann, E. 2000. Prebiotics & probiotics-part one. Dairy Industries International. July/August p. 17-18.
Oku, T. 1994. Special physiological functions of newly developed mono- and oligosaccharides. Functional Foods, Goldberg, I., New York, N.Y.: Chapman & Hall. pp. 202-218.
Orafti. 1999. Technical properties of Raftiline. Orafti, Inc. 101 Lindenwood Dr. Malvern, Pa. 19355 USA.
Reddy, G. V., Friend, B. A., Shanhani, K. M., and Farmer, R. E. 1983. Antitumor activity of yogurt components. J. Food Protection 46:8.
Ringo, S. M. 1999. International society of beverage technologists carbon dioxide guidelines. Food Safety Magazine, 20-24.
Roberfroid, M. B. 1997. Prebiotics and symbiotic, concepts and overview of nutritional properties. IFT Annual Meeting, Orlando, Fla., Abstract 73-2.
Surono, I. S. and Hosono, A. 1996. Antimutagenicity of milk cultured with lactic acid bacteria from Dedih against mutagenic Terasi. Milchwissenschaft 51:493-497.
Tamura, Z. 1983. Nutrition of bifidobacteria. Bif. Microflora 2:3-16.
US Food and Drug Administration. Dietary Supplement Health and Education Act of 1994. Public Law 103-417.
US Food and Drug Administration. Nutrition Labeling and Education Act of 1990. Public Law 101-535.
Vijayvendra, S. V. N. and Gupta, R. C. 1992. Therapeutic importance of bifidobacteria and Lactobacillus acidophilus in fermented milks. Indian Dairyman 44:595-599.
Young, J. N. 1997. Developments in probiotics, prebiotics, and symbiotic: a European perspective. IFT Annual Meeting, Orlando, Fla., Abstract 73-7.
AOAC. 1984. Ch. 16: Dairy Products. In Official Methods of Analysis Association of Official Analytical Chemists, 14th Edition. Washington, D.C. p. 284.
Bradley, R. L., Jr., Arnold, E., Jr., Barbano, D. M., Semerad, R. G., Smith, D. E., and Vines, B. K. 1992. Ch. 15: Chemical and physical methods. In Standard Methods for the Examination of Dairy Products, 16th Ed., R. T. Marshall (Editor), American Public Health Association, Washington, D.C. pp. 437-440.
Charteris, W. P., Kelly, P. M., Morelli, L., and Collins, J. K. 1998. Development and application of an in vitro methodology to determine the transit tolerance of potential probiotic Lactobacillus and Biftdobacterium species in the upper human gastrointestinal tract. Journal of Applied Microbiology. 84:759-768.
Frank, J. F., Ghristen, G. L., and Bullerman, L. B. 1992. Ch. 8: Tests for groups of microorganisms. In Standard Methods for the Examination of Dairy Products, 16th Ed., R. T. Marshall (Editor), American Public Health Association, Washington, D.C. pp. 281-283.
Guo, M. R. and Kindstedt, P. S. 1995. Age-related changes in the water phase of Mozzarella cheese. Journal of Dairy Science. 78:2099-2107.
Houghtby, G. A., Maturin, L. J., and Koenig, E. K. 1992. Ch. 6: Microbiological count methods. In Standard Methods for the Examination of Dairy Products, 16th Ed., R. T. Marshall (Editor), American Public Health Association, Washington, D.C. pp. 213-225.
International Dairy Federation. 1993. Provisional IDF International Standards. 20B:1993: Part 3. IDF, Brussels, Belgium.
Marteau, P., Minekus, M., Havenaar, R., and Huis In't Veld, J. H. J. 1997. Survival of lactic acid bacteria in a dynamic model of the stomach and small intestine: Validation and the effects of bile. Journal of Dairy Science. 80:1031-1037.
Nighswonger, B. D., Brashears, M. M., and Gilliland, S. E. 1996. Viability of Lactobacillus acidophilus and Lactobacillus casei in fermented milk products during refrigerated storage. Journal of Dairy Science. 79:212-219.
Sanders, M. E., Walker, D. C., Walker, K. M., Aoyama, K., and Klaenhammer, T. R. 1996. Performance of commercial cultures in fluid milk applications. Journal of Dairy Science. 79:943-955.
Sanh, N. P., Lankaputhra, W. E. V., Britz, M., and Kyle, W. S. A. 1995. Survival of L. acidophilus and Bifidobacterium bifidum in commercial yogurt during refrigerated storage. Int. Dairy J. 5:515-521.
Tornberg, E. 1978. The application of the drop volume technique to measurement of the adsorption of proteins at interfaces. J. Colloid Interface Sci. 64:391-402.
Vinderola C. G., and Reinheimer, J. A. 2000. Enumeration of Lactobacillus casei in the presence of L. acidophilus, bifidobacteria and lactic acid bacteia in fermented dairy products. International Dairy Journal. 10:271-275.

What is claimed is:

1. A symbiotic food product, comprising a mixture of probiotic and prebiotic components, wherein the probiotic component comprises at least about 10⁶ CFU/g of a lactic acid forming microorganism.

2. The symbiotic food product according to claim 1, wherein the probiotic component comprises at least about 10⁷ CFU/g of a lactic acid forming microorganism.

3. The symbiotic food product according to claim 1, wherein the probiotic component comprises a Lactobacillus spp., Bifidobacterium spp., or a combination thereof.

4. The symbiotic food product according to claim 1, wherein the prebiotic component comprises inulin or an oligofructose.

5. The symbiotic food product according to claim 1, wherein the prebiotic component comprises 2°-60° of polymerization.

6. The symbiotic food product according to claim 1, wherein the probiotic component inhibits the growth of one or more pathogenic microorganisms in the gastrointestinal tract.

7. The symbiotic food product according to claim 1, wherein the food product is a dairy product, a soy-based product, or a combination thereof.

8. The symbiotic food product according to claim 7, wherein the product is carbonated.

9. The symbiotic food product according to claim 8, wherein the product comprises 0.5 volumes of CO₂.

10. The symbiotic food product according to claim 8, wherein the product comprises 1.0 volumes of CO₂.

11. The symbiotic food product according to claim 8, wherein the product comprises 1.5 volumes of CO₂.

12. The symbiotic food product according to claim 8, wherein the product comprises 2.0 volumes of CO₂.

13. The symbiotic food product according to claim 1, wherein the product comprises about 1-3% by weight of the prebiotic component.

14. The symbiotic food product according to claim 1, wherein the product is in the form of a beverage, or a frozen product based thereon.

15. The symbiotic food product according to claim 1, wherein the product is in a frozen form.

16. The symbiotic food product according to claim 1, wherein the product is in a yogurt-like form.

17. The symbiotic food product according to claim 16, comprising polymerized whey protein.

18. A method of manufacturing a symbiotic food product in the form of a beverage or frozen product based thereon, wherein the food product comprises a mixture of prebiotic and probiotic components, comprising:
(a) combining prebiotic and probiotic components together in a liquid to form an inoculated mixture;
(b) fermenting the inoculated mixture until a pH of about 4.5 is achieved; and
(c) agitating the mixture to produce a beverage or, optionally, freezing the mixture.

19. The method according to claim 18, wherein step (c) comprises an additional step of introducing CO₂ into the mixture and sealing the CO₂-containing mixture within a container.

20. The method according to claim 19, wherein 0.5-2.0 volumes of CO₂ are introduced into the mixture.

21. The method according to claim 18, wherein the liquid comprises a dairy product, a soy-based product, or a combination thereof.

22. A method for identifying one or more strains of lactic acid-producing bacteria for use in generating a symbiotic beverage or a frozen product based thereon, comprising:
(a) introducing one or more strains of such bacteria into a dairy product or soy-based product or combination thereof comprising a prebiotic component, and
(b) selecting for bacteria with survival rates of at least 10⁶ CFU/ml.

23. The method according to claim 22, wherein one or more exogenous nucleic acids are introduced into the bacteria.

24. The method according to claim 22, wherein the dairy product or soy product is carbonated and bacteria are identified which are able to grow in the presence of 0.5-2.0 volumes of CO₂.

25. A culture of bacteria produced according to the method of claim 22.

26. The symbiotic food product of claim 1, wherein the probiotic component comprises three or more of: L. acidophilus, L. paracasei subsp. casei, Bifidobacteria, L. bulgaricus and Streptococcus thermophilus.

27. The symbiotic food product of claim 1, wherein the probiotic component comprises four or more of: L. acidophilus, L. paracasei subsp. casei, Bifidobacteria, L. bulgaricus and Streptococcus thermophilus.

28. The symbiotic food product of claim 1, wherein the probiotic component comprises L. acidophilus, L. paracasei subsp. casei, Bifidobacteria, L. bulgaricus and Streptococcus thermophilus.

29. The symbiotic food product of claim 26, wherein the food product is dairy-based.

30. The symbiotic food product of claim 1, wherein the probiotic component comprises L. acidophilus, L. plantarum (B28) and L. plantarum (B29).

31. The symbiotic food product of claim 1, wherein the food product is soy-based.

32. The method according to claim 18, wherein the probiotic component comprises three or more of: L. acidophilus, L. paracasei subsp. casei, Bifidobacteria, L. bulgaricus and Streptococcus thermophilus.

33. The method according to claim 18, wherein the probiotic component comprises four or more of: L. acidophilus, L. paracasei subsp. casei, Bifidobacteria, L. bulgaricus and Streptococcus thermophilus.

34. The method according to claim 18, wherein the probiotic component comprises L. acidophilus, L. paracasei subsp. casei, Bifidobacteria, L. bulgaricus and Streptococcus thermophilus.

35. The method according to claim 18, wherein the probiotic component comprises L. acidophilus, L. plantarum (B28) and L. plantarum (B29).

36. The method according to claim 32, wherein the food product is dairy-based.

37. The method according to claim 32, wherein the food product is soy-based.

38. A starter culture comprising L. acidophilus, L. paracasei subsp. casei, Bifidobacteria, L. bulgaricus and Streptococcus thermophilus.

39. A starter culture comprising L. acidophilus, L. plantarum (B28) and L. plantarum (B29).

40. A food product comprising L. acidophilus, L. paracasei subsp. casei, Bifidobacteria, L. bulgaricus and Streptococcus thermophilus.

41. A food product comprising L. acidophilus, L. plantarum (B28) and L. plantarum (B29).

42. The symbiotic food product according to claim 1, wherein the prebiotic component comprises oats.

43. The symbiotic food product according to claim 42, wherein the food product is in the form of a beverage.

44. The symbiotic food product according to claim 42, wherein the food product is in a frozen form.

45. The symbiotic food product according to claim 42, wherein the food product is in a yogurt-like form.

46. The symbiotic food product according to claim 45, comprising polymerized whey protein.

47. The symbiotic food product according to claim 42, wherein the probiotic component comprises L. plantarum (B28), L. casei ssp. pseudoplantarum (B29) and L. acidophilus.

48. The symbiotic food product according to claim 42, wherein the probiotic component comprises a bacteria isolated from fermented Bulgarian cereal.

49. The symbiotic food product of claim 42, wherein the food product does not comprise dairy or soy components.

50. The symbiotic food product according to claim 45, wherein the probiotic component comprises Streptococcus thermophilus, L. delbrueckii subsp. bulgaricus, L. acidophilus, L. casei, and Bifidobacteria.

51. The method according to claim 18, wherein the prebiotic component comprises oats.

52. A food product comprising L. plantarum (B28), L. casei ssp. pseudoplantarum (B29) and L. acidophilus.
